(19) United States
(12) Patent Application Publication
(10) Pub. No.: US 2008/0264216 A1
(43) Pub. Date: Oct. 30, 2008

(54) Snap Ring Pliers

(76) Inventor: Seamus Duffy, Longford (IE)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/629,561

(22) PCT Filed: Jun. 14, 2005
(86) PCT No.: PCT/IB05/02361

§ 371 Date: May 20, 2008

(30) Foreign Application Priority Data
Jun. 14, 2004 (IE) 2004/0399

(51) Int. Cl. B25B 7/12; B25B 7/02; B25B 7/14

(52) U.S. Cl. 81/302; 81/424.5; 81/319

(57) ABSTRACT

The jaw portion comprises cross levers centrally connected by a rotatable central axis with a throughbore and outwardly connected by lever pivots to parallel jaws (within clots at one end) with tapered operating tips at either end.

### FIELD OF THE INVENTION

This invention relates to circlip pliers or snap ring pliers which are well known for the removal or replacement of circlips (in the U.S.A referred to as “snap rings”) into their retaining grooves. There are two main types; internal and external. The internal type reduces the circumference of the circlip; the external type expanding the circlip circumference.

### BACKGROUND OF THE INVENTION

The known types of snap ring pliers work in a similar fashion to scissors. The handles pivoting around a fulcrum in order to lever the circlip via the levered end operating prongs in the required direction. Most circlips consist of an open ring of thin spring steel with a hole at the open ends of the ring. The holes are for the engagement of the operating prongs of the snap ring pliers. Dependant upon the orientation of the levered end operating prongs the circlip either opens or closes as the snap ring plier handles are operated. The operating prongs can be straight or if required angled in order to conveniently work in confined spaces. As circlips are made in many different sizes, large and small circlip pliers are manufactured. The snap ring engagement holes also differ in size and the operating prong ends are sized appropriately. The operating prongs can be either fixed or interchangeable.

To enable installation or removal most snap rings are made with apertures hereinafter termed “engagement holes”, at the open ends by which a ring is engaged and then either expanded or contracted by the use of suitable snap ring pliers. These circlips or snap rings hereinafter termed “retaining rings” are supplied as internal or external. The external type rings normally engage an annular groove formed in a shaft to inhibit axial movement of a bearing, pulley or gear mounted upon the shaft. External retaining rings are removed or replaced by expanding their circumference by the operation of the circlip pliers tips engaged into the retaining ring engagement holes thereby expanding the retaining ring until its internal diameter is greater than the shaft diameter.

The internal type of retaining ring is used to retain such as bearings or shafts within a bore. When installing or removing such a retaining ring its circumference is reduced using the snap ring pliers in order to pass into or out from a suitable internal retaining groove within a bore.

Tools for the operation of external type retaining rings are normally used for this single purpose. The internal type retaining ring tool also being of a single purpose necessitating the operator to have both types in order to operate external and internal retaining rings.

Snap ring pliers are available which are of dual purpose such as GB Patent 1, 334, 877 which illustrates a tool with a single pivot shaft, but two pivot hole portions. When the shaft is placed in one pivot hole, the tool acts as external retaining snap ring pliers and when placed in the other hole portion, the tool becomes internal retaining ring pliers. Most available retaining ring tools include a removable tip in a positioning groove or slot in either or both the jaw or clamping plate. The mounting arrangement must not only secure the longitudinal position of a tip, but in the case of angled tips, must also restrain or inhibit rotation of the tip with respect to the jaw and clamping plate. As the pliers are used the tips move in an arc, thereby the rotation of the tip within the positioning groove or slot during operation does not provide the optimum 90° angle of engagement between the tips and retaining ring apertures especially the straight tips. The angle of engagement changing as the tips are opened or closed. In some circumstances the angle is severe enough to cause disengagement.

It is an object of the present invention to provide a snap ring plier device in which the above mentioned disadvantages are substantially overcome.

### STATEMENT OF THE INVENTION

According to one aspect of the present invention, there is provided pliers for operating snap rings, the pliers comprising a handle portion and a jaw portion mounted on the handle portion, the jaw portion being adapted to operate in a first position in which the pliers engage an internal snap ring and a second position in which the pliers engage an external snap ring, the jaws comprising operating tips for engaging the apertures in a snap ring, characterised in that the operating tips have a tapered surface, the width of the tips reducing from the end remote from the jaws towards the end adjacent to the jaws, and an abutment shoulder between the narrow end of the operating tips and the jaws to engage a snap ring during insertion or removal.

According to the present invention there is provided snap ring pliers wherein the plier tips remain substantially at the optimum 90° angle of engagement throughout their use. The plier tips move in a parallel way relative to each other enabling the plier tips to always be at the optimum angle. The plier tips are preferably formed as part of the parallel jaws and are in the form of reverse cones.

Further to the present invention there is provided parallel jaw, locking snap ring pliers comprising of a jaw portion of two cross levers centrally connected by a rotatable central axis with a throughbore and outwardly connected by lever pivots (at one end within slots) to parallel jaws having suitable plier tips, hereinafter termed operating tips at either end.

The plier tips are in the form of reverse cones, the wide part of the cone being at the extremity of the plier tip. As the plier tips engage the snap ring engagement holes and the pliers are operated the snap ring is securely engaged by the concave of the reverse cone tip substantially providing a securing device during the operation of the snap ring placement or removal.

The handle portion has two overlaid sections rotatably coupled by an axis joint with a throughbore and two sets of two activating pins mounted equidistant therefrom, one set of pins fitted to the levering end of the handle portion on one side of the handle portion and the other set of actuating pins fitted to the levered end on the reverse side of the handle portion. One handle has a pivot and resilient section recess the other handle has a locking profile for interaction with the locking pawl.

The locking portion comprises a lever rotatable around a fulcrum pin with a locking pawl and locking lever biased in the inward direction by the resilient section at one side of the fulcrum pin and a release lever formed at the other end. As the handle portion is operated the locking pawl “ratchets” accordingly over the shaped teeth of the handle portion locking profile. The locking lever end of the locking portion—the locking pawl, has a compatible profile to that of the locking profile on the handle portion levered end which is substantially equidistant from the axis joint centre. As the pressure of the operated handle portion is released the locking pawl is propelled inwards by the resilient section, engaging the shaped teeth of the handle locking portion locking the handle portion open at that position. To release the locking function the handle portion is slightly operated and the release lever operated disengaging the locking pawl. The handle portion is then allowed to retain it's at rest position aided by its resilient member/retaining ring tension whilst the release lever is still operated.

When operating external retaining rings the jaw portion is threepoint mounted via a latching bolt or screw portion fitted through the axis joint and central axis throughbores and onto the two actuating pins on the handle portion levered end, engaging similarly centrally equidistant cross lever operating holes. The screw portion preferably consists of a pivot bolt having a plurality of grooves fitted parallel along the length of its male thread. The central axis throughbore has similar placed grooves substantially providing a female mirror of the pivot bolt male threaded portion, such that when the pivot bolt is entered into the central axis throughbore it's threads can easily move in or out of groves therein, whereas when the pivot bolt is rotated within the axis joint throughbore their threads can mesh and conveniently lock the jaw portion and the handle portion together. As the handle portion is operated the parallel jaws are forced open by the action of the actuating pins rotating the cross levers attached to the parallel jaws by the lever pivots. The reverse cone operating tips at the end of the parallel jaws within the retaining ring apertures opening the external retaining ring. When the jaw portion is fitted to the opposite side of the handle portion engaging the actuating pins fitted to the handle levering end, operating the handle portion forces the parallel jaws closed, closing as required the worked internal retaining ring. If required a resilient member fitted between the handles ensures the levering end of the handles remain open and the levered end remains closed when at rest. By virtue of the reverse cone tips and their parallel operation the retaining ring is effectively locked onto the operating tips during it's operation allowing the retaining ring to be robustly positioned with safety and ease.

In summary there is provided parallel jaw locking snap ring pliers wherein the operating tips remain substantially at the optimum 90° angle of engagement throughout their use. The operating tips move in a parallel way relative to each other enabling the operating tips to always be at the optimum angle. The operating tips are preferably formed as part of the parallel jaws although it is understood that the preferably reverse cone operating tips that engage the retaining ring apertures to operate the retaining rings can be interchangeable if required. The jaw portion can quickly and conveniently be fitted or removed from the handle portion by the utilisation of the pivot bolt threaded portion having parallel grooves which are the same or less width than the corresponding grooved threads within the central axis throughbore, allowing the pivot bolt threaded portion to slide in or out of position within the central axis throughbore, yet requires less than quarter of a turn of the pivot bolt to lock the two portions together.

The jaw portion can be detached from the handle portion and rotated in order to engage differing operating tips for example angled or different tip sizes. The engagement of the jaw portion onto the actuating pins fitted to the handle portion levered end allows the pliers to be operated to distend external retaining rings. The further engagement of the jaw portion onto the levering end actuating pins fitted to the reverse side of the handle portion allows the pliers to be operated to constrict internal retaining rings.

The locking portion resiliently engages the locking pawl against the handle portion locking profile. As the handle portion is squeezed the handle portion levered end opens and disengages the locking pawl from the circumferentially equal radius to the axis joint locking profile.

The handle portion pressure when released allows the locking pawl to resiliently engage into the locking profile substantially locking the operating tips and worked retaining ring at that position. In order to release the locked operated retaining ring some pressure is used to slightly close the handles towards each other and the locking portion release lever is operated which pivots around the fulcrum pin compressing the resilient section disengaging the locking pawl allowing the handle portion to be deactivated as required.

### BRIEF DESCRIPTION OF THE EMBODIMENTS

Embodiments of the present invention will now be described by way of example, with reference to the accompanying drawings in which:

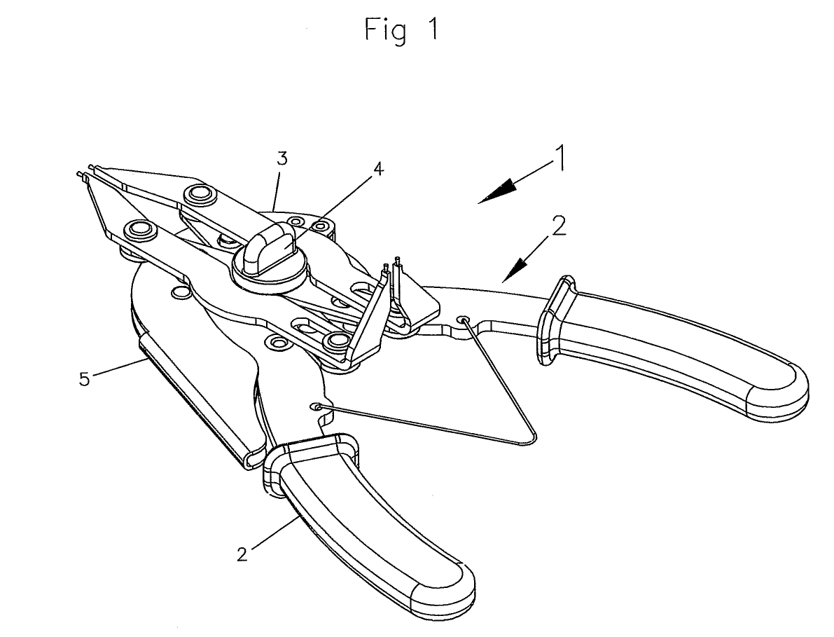

FIG. 1 is a perspective view of the parallel jaw locking snap ring pliers.

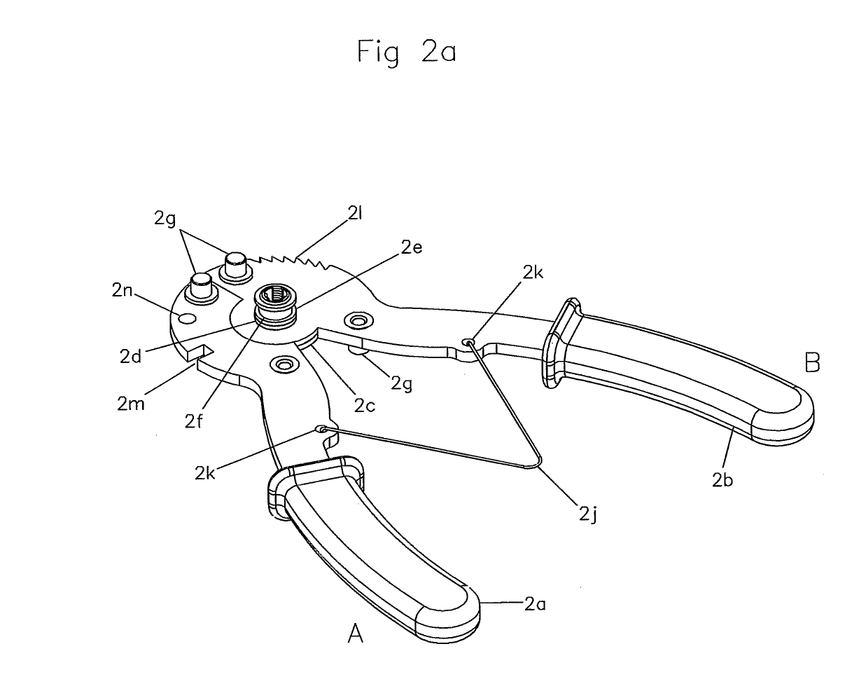

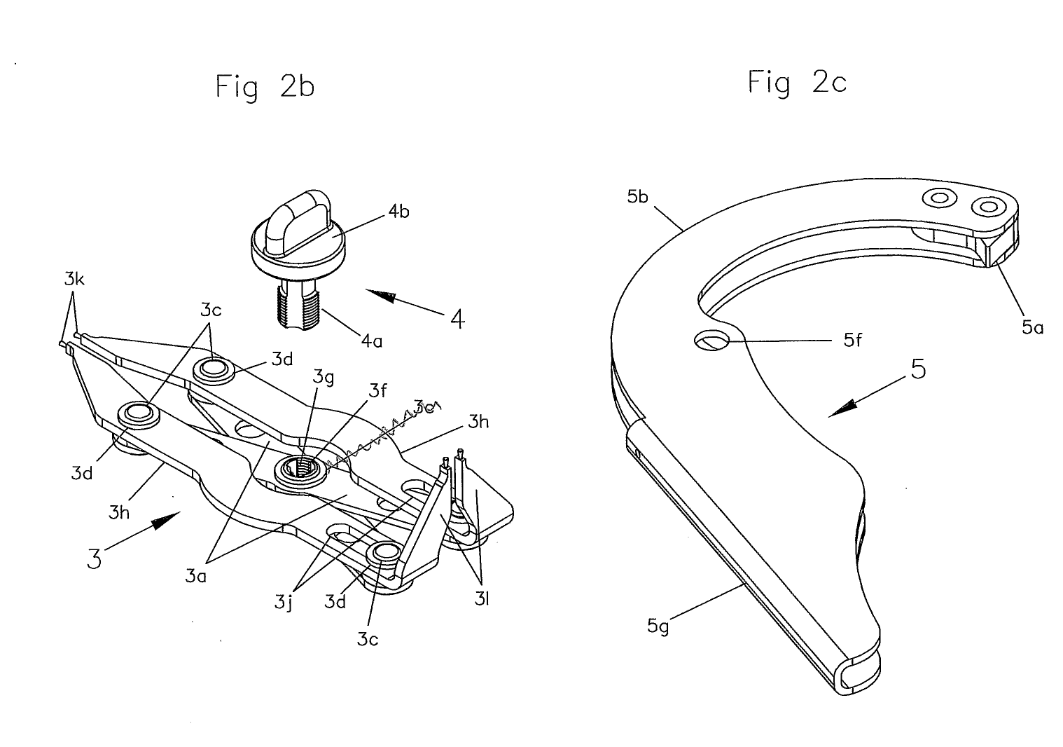

FIG. 2a is a perspective view of the handle portion of the snap ring pliers.

FIG. 2b is a perspective view of the jaw portion of the snap ring pliers illustrating in particular the reverse cone operating tips and the pivot bolt.

FIG. 2c is a perspective view of the locking portion of the snap ring pliers.

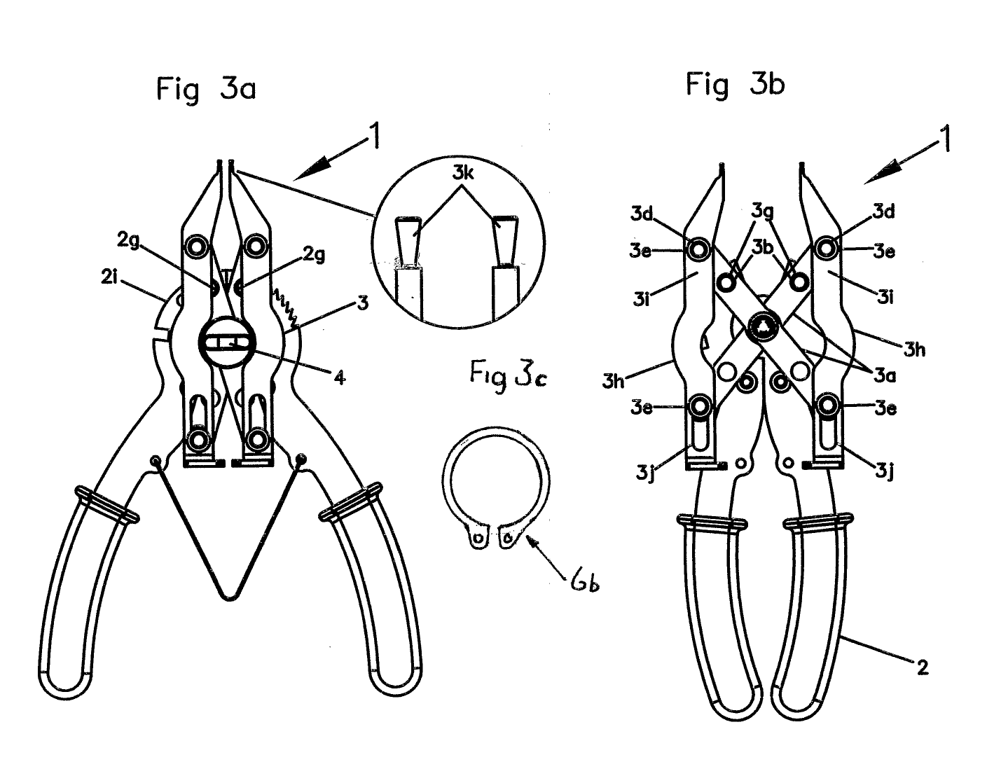

FIG. 3a is a plan view -of the parallel jaw locking snap ring pliers at rest less the locking portion. The jaw portion fitted to the actuating pins on the levered end of the handle portion. The reverse cone operating tips being highlighted.

FIG. 3b is a plan view of the parallel jaw locking snap ring pliers less the locking portion in an operated position, the actuating pins on the levered end actuating the jaw portion.

FIG. 3c is a plan view of an external retaining ring.

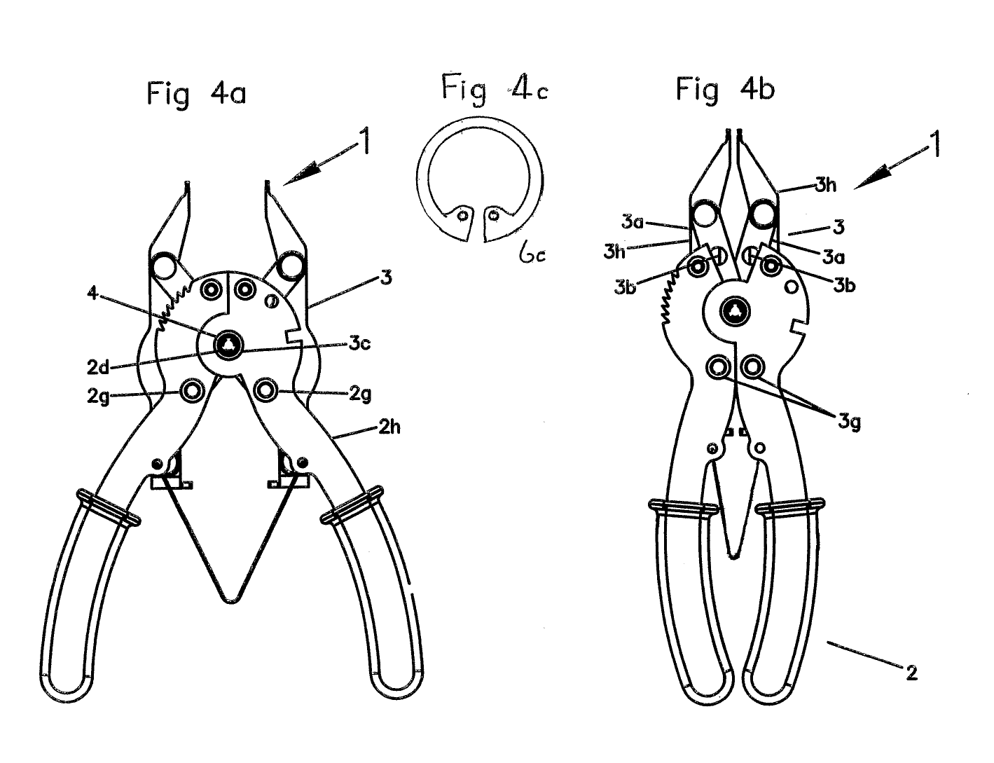

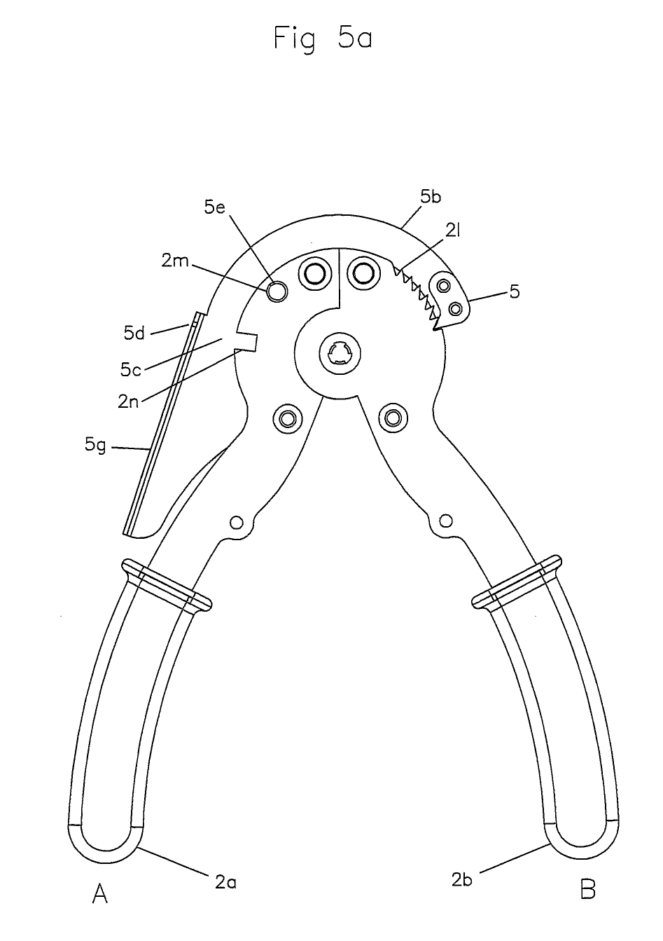

FIG. 4a is a plan view of the parallel jaw locking snap ring pliers less the locking portion at rest, the jaw portion engaging the actuating pins on the levering end of the handle portion.

FIG. 4b is a plan view of the parallel jaw locking snap ring pliers less the locking portion in an operated position, the actuating pins on the levering end of the handle portion, actuating the jaw portion.

FIG. 4c is a plan view of a internal retaining ring.

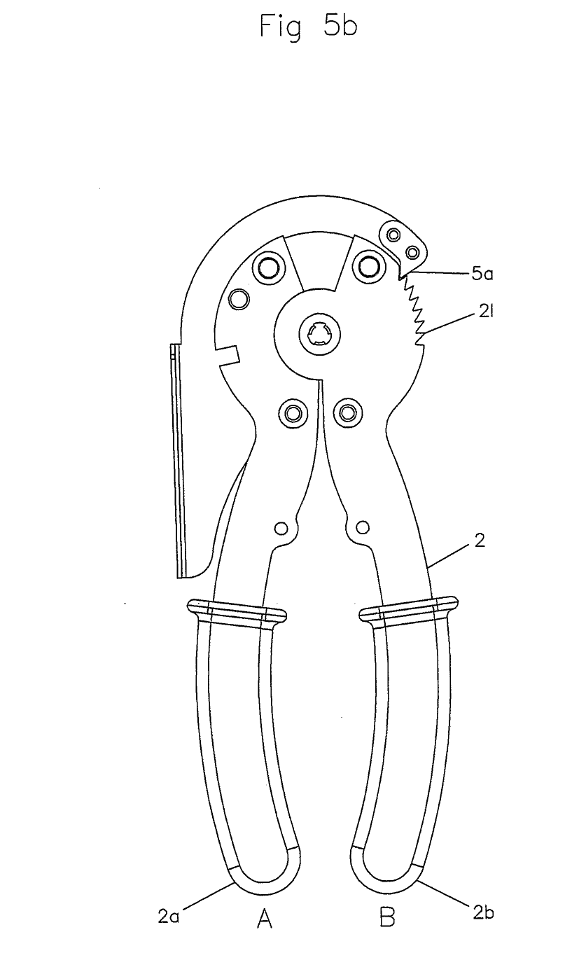

FIG. 5a is a plan view of the parallel jaw locking snap ring pliers at rest less the jaw portion at rest showing the locking portion sectioned.

FIG. 5b is a plan view of the parallel jaw locking snap ring pliers less the jaw portion, when operated illustrating a locked portion.

FIG. 5c is a plan view of the parallel jaw locking snap ring pliers less the jaw portion, when operated, illustrating the release lever deactivating the locking pawl from the handle portion locking profile.

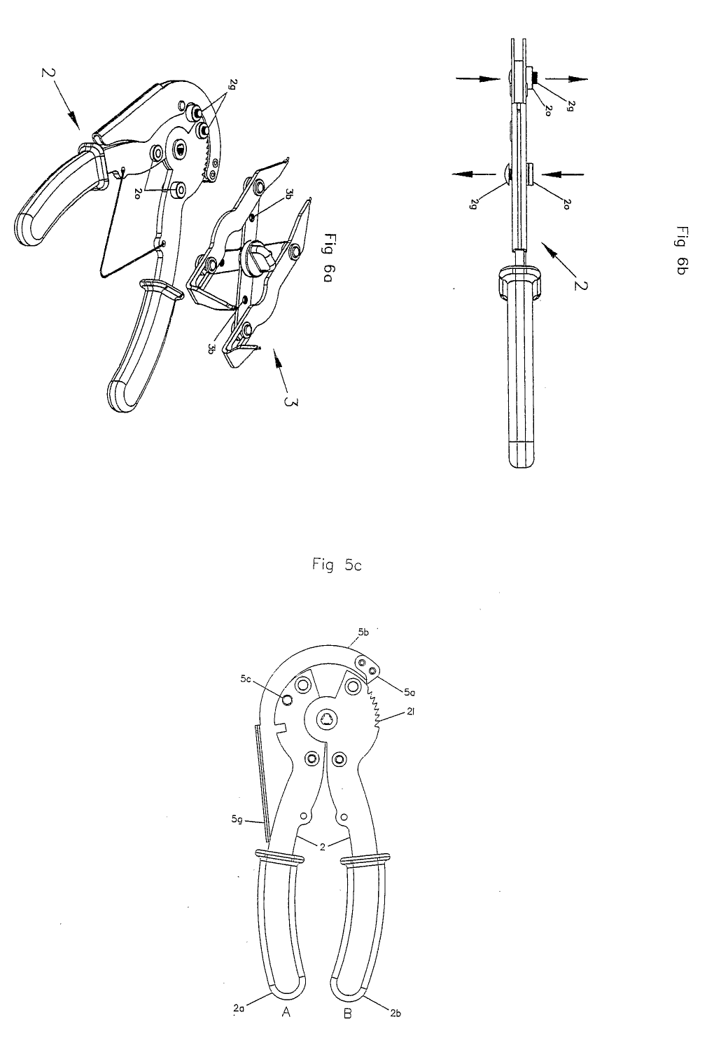

FIG. 6a is a perspective view of the parallel jaw snap ring pliers, the jaw portion shown separately, threaded posts and actuating pins are mounted on only one face of the handle portion, they are illustrated with the top set (away from the handle grips) with the male thread pins fully engaged and the bottom male threaded pins fully withdrawn to enable use on external snap rings, the threaded actuating pins can engage with similar threaded cross lever operating holes.

FIG. 6b is a side elevation view of the parallel jaw snap ring pliers, with the jaw portion removed, the bottom (nearest the handle grips) threaded actuating pins shown withdrawn and the top threaded actuating pins shown engaged.

### REFERENCE TO THE DRAWINGS

In the present invention, like features will be given like numbers. In reference to the drawings:
(1) Parallel jaw locking snap ring pliers
(2) Handle portion throughbore
(2a) Handle A
(2b) Handle B pivot hole
(2c) Overlaid section pivot slot
(2d) Axis joint hole tips
(2e) Axis joint operating tips
(2f) Axis joint throughbore
(2g) Actuating pins section
(2h) Levering end section
(2i) Levered end
(2j) Resilient member
(2k) Resilient member locating holes
(2l) Locking profile section
(2m) Locking fulcrum hole
(2n) Resilient section retaining aperture
(2o) Threaded posts
(3) Jaw portion
(3a) Cross lever
(3b) Cross lever operating holes
(3c) Cross lever central axis hole
(3d) Cross lever pivot holes
(3e) Lever pivots
(3f) Central axis
(3g) Central axis throughbore
(3h) Parallel jaw
(3i) Parallel jaw lever pivot hole
(3j) Parallel jaw lever pivot slot
(3k) Parallel jaw operating tips
(3l) Parallel jaw angled operating tips
(4) Pivot bolt
(4a) Pivot bolt locking section
(4b) Pivot bolt operating section
(5) Locking portion
(5a) Locking portion
(5b) Locking pawl
(5c) Locking resilient section
(5d) Locking resilient section retention pin
(5e) Fulcrum pin
(5f) Fulcrum pin hole
(5g) Release lever
(6) Retaining ring holes
(6a) Retaining ring axis hole apertures
(6b) External retaining holes ring
(6c) Internal retaining ring

### DESCRIPTION OF THE PREFERRED EMBODIMENTS

The embodiments described herewith will be described with reference to FIGS. 1-6. Throughout the drawings, like parts will be referred to by the same numerals.

FIG. 1 is a perspective view of the Parallel jaw locking snap ring pliers (1) illustrating the handle portion (2) and jaw portion (3) rotatably joined by the pivot bolt (4), the locking portion (5) is also shown. FIGS. 2a, 2b and 2c illustrate in perspective the various components of the Parallel Jaw Locking snap ring pliers (1). FIG. 2a shows the handle portion (2) consisting of handle A (2a) and Handle B (2b) joined at the overlaid section (2c) through the axis joint holes (2d) by an axis joint (2e) with a throughbore (2f). The actuating pins (2g) illustrated on the levering end (2h) and the resilient member (2j) fitted within its locating holes. The locking profile (2l) is shown on the levered end of the Handle B (2b) whilst the levered end of Handle A (2a) incorporates the fulcrum hole (2n) and resilient section retaining apertures (2m). FIG. 2b shows the jaw portion (3), the cross levers (3a) joined together through their central axis holes (3c) by the central axis (3f) having a throughbore (3g). Lever pivots (3c) rotatably join the parallel jaws (3h) to the cross levers (3a) via their respective cross lever pivot holes (3d) and parallel jaw lever pivot holes (3i) at one end of the parallel jaws (3h) and through the parallel jaw lever pivot slots (3j) at the opposite end of the parallel jaws (3h). In one example of the present invention the parallel jaws (3h) have straight operating tips (3k) at one end and angled operating tips (3l) at the other extremity. FIG. 2b illustrates a known pivot bolt (4) incorporating a pivotal latch (4a) and resilient section (4b). FIG. 2c shows the locking portion (5) illustrating the locking pawl (5a) and lever (5b) at one side of the fulcrum pin hole (5f) and the release lever (5g) adjoined at the other.

FIGS. 3a and 3b illustrate the Parallel jaw locking snap ring pliers (1) assembled for use upon external retaining rings (6b) as the example shown in FIG. 3c . FIG. 3a illustrates the jaw portion (3) three point mounted on the handle portion levered end (2i) via the actuating pins (2g) and centrally locked via the pivot bolt (4) the parallel jaw locking snap ring pliers (1) are at rest. The reverse cone operating tips (3k) being highlighted. The width of the tips reduces from the end remote from the jaws 3 to the end adjacent the jaws. A retaining shoulder is defined on the end of the jaws around the narrowest part of the operating tips. When the operating tips are inserted into the actuating apertures of the snap ring, the snap ring slides down the tapered outer surface of the operating tips and is then held on the retaining shoulder between the jaws and the operating tips. The resilient nature of the snap ring ensures that during operation of the pliers, the snap ring is firmly held in position on the jaws of the pliers and this leads to more secure handling and placement of the snap rings.

FIG. 3b shows the parallel jaw locking snap ring pliers whereas the handle portion (2) is operated, the cross levers (3a) are rotated by the actuating pins (3g) within the cross lever operating holes (3b) forcing the parallel jaws (3h) open, the lever pivots (3e) sliding within the parallel jaw lever pivot slots (3j) at one end of the parallel jaws (3h) and rotating within the cross lever pivot holes (3d) and the parallel jaw lever pivot holes (3i) at the other end. FIGS. 4a and 4b illustrate the parallel jaw locking snap ring pliers (1) assembled for use upon internal retaining rings (6c) as the example shown in FIG. 4c. FIG. 4a illustrates the jaw portion (3) three point mounted on the handle portion levering end (2h) via the actuating pins (2g) and centrally rotationally locked via the pivot bolt (4) within the cross lever central axis hole (3c) and the handle portion axis joint hole (2d), the parallel jaw locking snap ring plier is at rest. FIG. 4b shows the parallel jaw locking snap ring plier whereas the handle portion (2) is operated, the cross levers (3a) are rotated by the actuating pins (3g) within the cross lever operating holes (3b) forcing the parallel jaws (3h) closed.

FIG. 5a shows the parallel jaw locking snap ring plier handles(2a, 2b) less the jaw portion (3) illustrating in particular the locking portion (5) in section. The locking pawl (5) attached to the locking lever (5b) at one side of the fulcrum pin (5e) within the locking fulcrum hole (2m) and the release lever (5g) adjoined at the other. The locking resilient section (5c) retained in place by the locking resilient retention pin (5d) and the resilient section retaining aperture (2n). The locking profile (2l) one way teeth are highlighted. FIG. 5b illustrates the parallel jaw locking snap ring pliers less the jaw portion (3) the handle portion (2) being operated, the locking pawl (5a) engaging the locking profile (2l) locking in position the handle portion (2). FIG. 5c shows the parallel jaw locking snap ring plier handles (2a, 2b),less the jaw portion (3),the handle portion(2) operated. The release lever (5g) is operated rotating around the fulcrum pin (5c) the adjoined locking lever (5b) disengaging the locking pawl (5a) from the locking profile (2l), allowing if required the handle portion to be de operated.

FIG. 6a is a perspective view of the parallel locking snap ring pliers (1), the jaw portion (3) shown separately. The actuating pins (2g) and corresponding threaded posts (2o) are threaded or any other means whereby the actuating pins (2g) can be extended or distended as required from the threaded posts (2o) and locked in position in order to operate the jaw portion (3) in either an inward or outward direction in order to operate internal (6c) or external snap rings (6b) whilst removing the requirement to disengage the jaw portion (3) and reposition it on the opposite handle (2) face. The threaded actuating pin (2g) can advantageously screw into corresponding threaded cross lever operating holes (3b). FIG. 6b is a side elevation view showing the screw type actuating pins (2g) within the threaded posts (2o) the top set extended and the set nearest the handle (2) centre distended.

1. Pliers for operating snap rings, the pliers comprising a handle portion and a jaw portion mounted on the handle portion, the handle portion comprising a pair of handles movable relative to one another by a user, wherein the jaw portion comprises a pair of jaws extending generally parallel to one another and being mounted to the handle portion via crossed levers so that the jaws are constrained to move in a substantially parallel action, each of said crossed levers being coupled to a respective one of the handles by a respective operating pin so as to open and close the jaws in response to pivotal movement of the handles, the jaws being provided with operating tips for engaging the apertures in a snap ring, the pliers being adaptable to operate in a first mode in which the pliers will engage and constrict an internal snap ring and a second mode in which the pliers will engage and expand an external snap ring, the position of each operating pin on its respective handle being selectable to change the mode of operation from said first mode to said second mode and vice versa.

2. Pliers according to claim 1, wherein said crossed levers and said handles are all arranged to pivot about a common axis.

3. Pliers according to claim 1, wherein the position of the operating pins, and hence the mode of operation of the jaws, can be changed without demounting the jaw portion from the handle portion.

4. Pliers according to claim 1, wherein said operating pins are threaded and deployable in a selected position by the provision of threaded apertures at the selectable positions on the handles.

5. Pliers according to claim 1, wherein the operating tips have a tapered surface, the width of the tips reducing from the end remote from the jaws towards the end adjacent to the jaws, and an abutment shoulder between the narrow end of the operating tips and the jaws to engage a snap ring during insertion or removal.

6. Pliers according to claim 5, wherein the operating tips of the jaws have a conical outer surface.

7. Pliers according to claim 5, wherein the operating tips are releasably mounted to the jaws to allow for different sized tips to be used.

8. Pliers according to claim 1, wherein the jaws have operating tips mounted at both ends and are mountable to the handle portion with either end deployed furthest from the handle

9. Pliers according to claim 7, wherein one end of the jaws are straight and the other end are bent at an angle.

10. Pliers according to claim 1, wherein the jaw portion is releasably mounted on the handle portion.

11. Pliers according to claim 1, wherein locking means are provided to lock the jaws of the pliers in a plurality of different open positions.

12. Pliers according to claim 11, wherein the locking means comprising a plurality of notches in the handle portion of the pliers and a locking member comprising an operating handle at one end and a pawl at the other to engage with the notches, the locking member being mounted on the handle through a pivot pin mounted on the handle.

13. Pliers according to claim 11, wherein release means are provided to release the locking member from engagement with the notches of the handle.

14. Pliers according to claim 1, wherein the handle portion is provided with a boss upon which the jaw portion in mounted

15. Pliers according to claim 14, wherein the handle portion comprises two legs, one of which overlies the other adjacent to the mounting boss.

16. Pliers according to claim 14, wherein the mounting boss has a central aperture which forms a threaded socket to receive a correspondingly threaded shaft of a retaining bolt to retain the jaw portion in position upon the handle portion.

17. Pliers according to claim 16, wherein said threaded aperture and threaded shaft have threads only on certain sections of their circumference, whereby the shaft can be disengaged and withdrawn from the socket with only a partial turn of each relative to the other.

18. Pliers comprising a handle portion and a jaw portion mounted on the handle portion, the handle portion comprising a pair of handles movable relative to one another by a user, wherein the jaw portion comprises a pair of jaws extending generally parallel to one another and being mounted to the handle portion via two crossed levers which are connected to one another by a central pivot and outwardly connected to the jaws by lever pivots, at one end within slots, so that the jaws are constrained to move together and apart while remaining substantially parallel.

19. Pliers as claimed in claim 18 wherein said jaws are provided with operating tips adapted for opening snap rings.
